(19) United States
(12) Patent Application Publication
(10) Pub. No.: US 2026/0141716 A1
(43) Pub. Date: May 21, 2026

(54) LEARNING-BASED METHOD OF ANALYZING BUILDING FAÇADE SEMANTIC INFORMATION AND AN APPARATUS FOR SUPPORTING THE METHOD

(71) Applicant: ELECTRONICS AND TELECOMMUNICATIONS RESEARCH INSTITUTE, Daejeon (KR)

(72) Inventors: Ji Sang Park, Daejeon (KR); Kyoung Hyun Park, Daejeon (KR)

(21) Appl. No.: 19/193,158

(22) Filed: Apr. 29, 2025

(30) Foreign Application Priority Data
Nov. 21, 2024 (KR) 10-2024-0167266

(51) Int. Cl. G06V 20/10; G06N 3/096; G06T 3/4046; G06V 10/764; G06V 10/774; G06V 10/82; G06V 20/62

(52) U.S. Cl. CPC G06V 20/176; G06N 3/096; G06T 3/4046; G06V 10/764; G06V 10/774; G06V 10/82; G06V 20/62

(57) ABSTRACT

An artificial intelligence (AI) device for classifying semantic information about a building façade through learning includes an input unit configured to obtain three-dimensional (3D) building data, including building façade texture data, as input data, an AI processor trained to generate a partial image including a detection target object, based on the building façade texture data, obtain detailed structure data of a sub structure of a building façade by using the partial image, apply the detailed structure data to a pre-trained AI model to recognize the sub structure of the building façade, and extract coordinate information about the recognized sub structure of the building façade to classify semantic information about a building façade structure, and an output unit configured to output the semantic information about the building façade structure classified by the AI processor.

### CROSS-REFERENCE TO RELATED APPLICATION(S)

This application claims the benefit of the Korean Patent Application No. 10-2024-0167266 filed on Nov. 21, 2024, which is hereby incorporated by reference as if fully set forth herein.

### BACKGROUND

### 1. Field of the Invention

The present disclosure relates to a method of analyzing building façade semantic information, and more particularly, to a learning-based method which may analyze building façade semantic information and may classify in building façade, based on an artificial intelligence model.

### 2. Description of Related Art

In the computer vision field, various image-based learning techniques have become available by using massive image data and millions of feature classes, and neural network models with deep layer structures have become effective to extract and to differentiate complicate features of different objects. The performance of learning-based techniques have become improved by resolving various problems, i.e., gradient loss often occurring within deep neural networks can be resolved through residual connections

Pre-trained models with massive datasets usually provide the better classification performance than those with small datasets, and significant amount of learning times can be reduced by merging pre-trained models with massive datasets and new datasets associated with objects of interest. New trained models can be applied for image classification, object detection, and image segmentation. However, it is difficult to obtain reasonable level of classification accuracy for all possible cases by using pre-trained model with general objects. To improve the level of accuracy for feature classification and image recognition, therefore, it is necessary to adopt fine tuning techniques to pre-trained models with additional training datasets with features of interest.

Three-dimensional (3D) building model data represents the development situations of cities and national lands. They may include a variety of attribute information such as building shapes, façade texture images, floor numbers, and materials. It is expected that 3D building model data will be widely used in a variety of applications, i.e., 3D virtual world construction and geospatial analysis services using digital twin technology. Building façade textures included in 3D building model data provide information about various detailed structures within building façades, and thus, additional attribute information associated with the building façade may be extracted through efficient analysis processes. Semantic information obtained in this manner is expected to be the important base capable of connecting the outsides and the insides of buildings.

Sub structures within building façades provide unique spectral and morphological representations because of their variety in terms of sizes, shapes, and colors. In order to extract semantic information from building façade textures using pre-trained models, however, it is recommended to prepare a new technical system, which efficiently adds shapes and colors of sub structures within those building façades into pre-trained models.

### SUMMARY

An aspect of the present disclosure is directed to providing a learning-based modeling method which may recognize and classify sub structures within building façades such as entrance doors and windows included in building façades from building façade textures, based on an automated method.

Another aspect of the present disclosure is directed to providing a method which may define a new data structure for storing relevant information so as to correlate external data and a system with information about a classified detailed structure, and thus, may correlate a building information model (BIM), corresponding to the inside of a three-dimensional (3D) building, with a space information database corresponding to an external space.

To achieve these and other advantages and in accordance with the purpose of the invention, as embodied and broadly described herein, there is provided an artificial intelligence (AI) device for classifying semantic information about a building façade through learning, the AI device including: an input unit configured to obtain three-dimensional (3D) building data, including building façade texture data, as input data; an AI processor trained to generate a partial image including a detected target object, based on the building façade texture data, obtain detailed structure data of a sub structure of a building façade by using the partial image, apply the detailed structure data to a pre-trained AI model to recognize the sub structure of the building façade, and extract coordinate information about the recognized sub structure of the building façade to classify semantic information about a building façade structure; and an output unit configured to output the semantic information about the building façade structure classified by the AI processor.

Moreover, in the present disclosure, the 3D building data may further include building shape data and building attribute data.

Moreover, in the present disclosure, the AI device may further include a memory configured to classify the semantic information about the building façade structure, output by the output unit, into image metadata and object data and store the image metadata and the object data.

Moreover, in the present disclosure, the AI processor may include: a conversion unit configured to enlarge a size of image data corresponding to the sub structure of the building façade; a preprocessing unit configured to apply detailed structure data of the sub structure of the building façade to the pre-trained AI model; and a model learning unit trained to recognize the sub structure of the building façade and classify the semantic information about the building façade structure, based on the coordinate information about the recognized sub structure of the building facade.

Moreover, in the present disclosure, the conversion unit may generate a partial image of the sub structure of the building façade, determine a magnification scale, corresponding to a size of a target image, as an image size conversion magnification of the partial image, and convert the partial image at the determined magnification scale.

Moreover, in the present disclosure, the partial image may be converted from a low-resolution image having a small size into a high resolution image having a large size, based on the determined magnification scale.

Moreover, in the present disclosure, the detailed structure data may include data corresponding to a target image and data corresponding to the sub structure of the building façade and data corresponding to a non-target image instead of the target image.

Moreover, in the present disclosure, the preprocessing unit may determine the number of target images to be equal or similar to the number of nontarget images.

Moreover, in the present disclosure, the preprocessing unit may apply the detailed structure data of the sub structure of the building façade to the pre-trained AI model through transfer learning and image fine tuning.

In another aspect of the present invention, there is a new method of classifying semantic information about a building façade through learning, the learning-based method including: a step of obtaining three-dimensional (3D) building data, including building façade texture data, as their input data; a step of generating a partial image including a detected target object, based upon the building façade texture data; a step of performing learning to obtain detailed structure data of a sub structure of a building façade by using the partial image and apply the detailed structure data to a pre-trained artificial intelligence (AI) model to classify semantic information about a building façade structure; and a step of generating the classified semantic information about the building façade structures.

Moreover, in the present disclosure, the step of performing the learning may include: a step of recognizing the sub structure of the building façade; and a step of extracting coordinate information about the recognized sub structure of the building façade.

Moreover, in the present disclosure, the method may further include a step of classifying the output semantic information about the building façade structure into image metadata and object data and storing the image metadata and the object data.

Moreover, in the present disclosure, the step of generating the partial image may include: a step of determining a magnification scale corresponding to a size of a target image, as an image size conversion magnification scale of the partial image; and a step of converting the partial image at the determined magnification scale.

In another aspect of the present invention, there is an artificial intelligence (AI) device trained to classify semantic information about a building façade, the AI device including: an AI processor configured to obtain three-dimensional (3D) building data as training data, to generate a partial image of a sub structure of a building façade in the 3D building data, to determine a magnification scale, corresponding to a size of a target image, as an image size conversion magnification scale for the partial image, to convert the partial image at the determined magnification scale, to learn detailed structure data of the sub structure of the building façade through an AI model, and to classify semantic information about building façade structure; and a memory configured to store the trained AI model.

The present disclosure may obtain semantic information about various sub structure included in a building façade by using artificial intelligence (AI) technology while minimizing an interaction of a user, based upon an automated form, and may provide sufficient attribute information to 3D building model data.

Moreover, the present disclosure may correlate semantic information, obtained from the outside of a building, with a BIM modeled on the inside of the building to construct integrated data where the inside of the building is correlated with the outside of the building, and thus, may be used in various geospatial analysis in future construction industry and the implementation of a digital virtual environment on a real space including a city where the inside and the outside of a building are integrated, based on the application of a digital twin technology concept.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide further understanding of the disclosure and are incorporated in and constitute a part of this application, illustrate embodiments of the disclosure and together with the description serve to explain the principle of the disclosure.

FIG. 1 illustrates an embodiment of an internal block diagram of an artificial intelligence (AI) device to which a method according to the present disclosure is applied.

FIG. 2 illustrates an embodiment of input data according to the present disclosure.

FIG. 3 illustrates an embodiment of an internal block diagram of a data training unit according to the present disclosure.

FIG. 4 illustrates an embodiment of output data according to the present disclosure.

FIG. 5 is a flowchart illustrating an embodiment of an operating method of a conversion unit according to the present disclosure.

FIG. 6 illustrates an embodiment which generates a partial image from input data according to the present disclosure.

FIG. 7 illustrates an embodiment of a process of converting an image size according to the present disclosure.

FIG. 8 illustrates an embodiment of a target image and a nontarget image according to the present disclosure.

FIG. 9 illustrates an embodiment of a process of calculating coordinate information and recognizing an object according to the present disclosure.

FIG. 10 illustrates an embodiment of a learning-based method of classifying building façade semantic information according to the present disclosure.

### DETAILED DESCRIPTION OF THE INVENTION

The terminology used herein is for the purpose of describing particular embodiments only and is not intended to be limiting of the invention. Unless otherwise defined, all terms used herein have the same meaning as commonly understood by one of ordinary skill in the art to which this invention pertains, and should not be interpreted as having an excessively comprehensive meaning nor as having an excessively contracted meaning. If technical terms used herein is erroneous that fails to accurately express the technical idea of the present invention, it should be replaced with technical terms that allow the person in the art to properly understand. The general terms used herein should be interpreted according to the definitions in the dictionary or in the context and should not be interpreted as an excessively contracted meaning.

It will be understood that although the terms including an ordinary number such as first or second are used herein to describe various elements, these elements should not be limited by these terms. These terms are only used to distinguish one element from another element. For example, a first element may be referred to as a second element without departing from the spirit and scope of the present invention, and similarly, the second element may also be referred to as the first element.

Hereinafter, embodiments described in the present disclosure will be described in detail with reference to the accompanying drawings, like reference numerals refer to like or similar elements regardless of reference numerals, and their repeated descriptions are omitted.

Moreover, in describing technology described in the present disclosure, when it is determined that detailed descriptions of related technology known to those of ordinary skill in the art obscure the gist of technology described in the present disclosure, the detailed descriptions are omitted. Also, the accompanying drawings are merely for helping easily understand the inventive concept described in the present disclosure, and it should not be construed that the accompanying drawings limit the inventive concept.

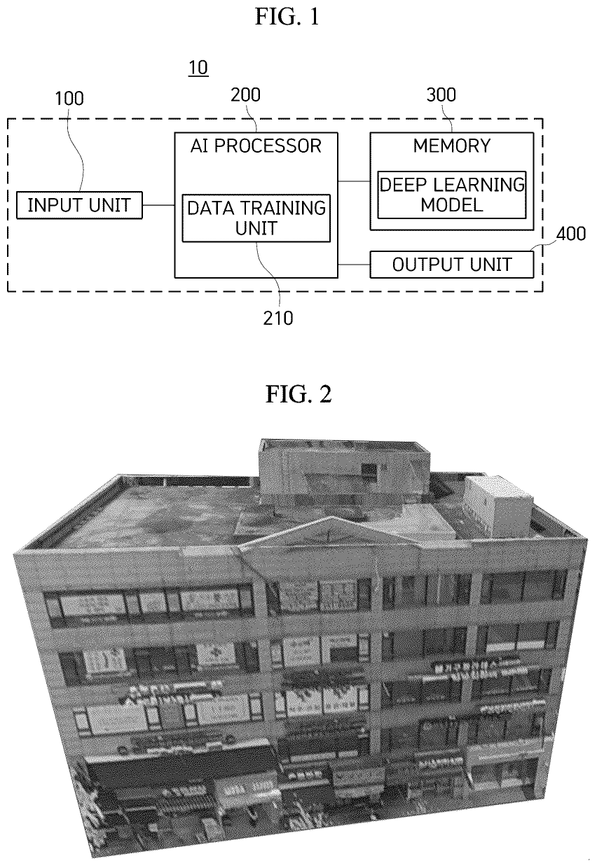

FIG. 1 illustrates an embodiment of an internal block diagram of an artificial intelligence (AI) device 10 to which a method according to the present disclosure is applied.

The AI device 10 may include an input unit 100, an AI processor 200, a memory 300, and an output unit 400.

The AI device 10 may be a computing device which may develop a neural network model and may include various electronic devices such as a portable phone, a camera, a server, a desktop personal computer (PC), a notebook PC, a tablet PC, and a vehicle, or may be implemented as a separate module type.

The input unit 100 may obtain data needed for the analysis of semantic information about a building façade. Input data obtained through the input unit 100 may include three-dimensional (3D) building data, and the 3D building data may include building shape data, building façade texture data, and building attribute data.

The building shape data may denote information about a shape of a building, may include information about all components configuring an appearance of the building, and may be defined as various formats such as OBJ, CityJson, and CityGML. The building façade texture data may include image data of a building façade in an image format form such as GIF, TIF, or JPG. The building attribute data may include various attribute information, associated with a corresponding building, such as an address, the number of floors, an owner, and the real world coordinates of building location. FIG. 2 illustrates an embodiment of input data according to the present disclosure. Referring to FIG. 2, it may be seen that a 3D building image is obtained as the input data.

The AI processor 200 may develop a neural network model by using a program stored in the memory 300. Particularly, the AI processor 200 may develop a neural network model for recognizing image data. Here, a neural network model for recognizing image data may be designed to simulate a brain structure of a human and may include a plurality of network nodes which simulate a neuron of a neural network of a human and have a weight. The plurality of network nodes may transmit and receive data therebetween to simulate a synaptic action of a neuron transmitting and receiving a signal through a synapse, based on each connection relationship. Here, the neural network may include a deep learning model which has advanced in a neural network model. The plurality of network nodes in the deep learning model may be disposed in different layers and may transmit and receive data, based on a convolution connection relationship. Examples of the neural network model may include deep learning techniques such as a deep neural network (DNN), a convolutional deep neural network (CNN), a recurrent neural network (RNN), a restricted Boltzmann machine (RBM), a deep belief network (DBN), and a deep Q-network and may be applied to fields of computer vision, voice recognition, natural language processing, and voice/signal processing.

Moreover, a processor which performs a function described above may be a general-use processor (for example, a central processing unit (CPU)), or may be an AI-dedicated processor (for example, a graphics processing unit (GPU)) for AI learning.

The memory 300 may store various programs and data needed for an operation of the AI device 10. The memory 300 may be implemented as a non-volatile memory, a volatile memory, flash memory, a hard disk drive (HDD), or a solid state drive (SDD). The memory 300 may be accessed by the AI processor 200, and read/recording/correction/deletion/update of data may be performed by the AI processor 200. Also, the memory 300 may store a neural network model (for example, a deep learning model) generated through a learning algorithm for the analysis of building façade semantic information according to an embodiment of the present disclosure.

Moreover, the AI processor 200 may include a data training unit 210 which develops a neural network model for the analysis of the building façade semantic information. The data training unit 210 may develop a criterion of training data which is to be used for the analysis of the building façade semantic information, or may develop a criterion of the classification and recognition of data by using the training data. The data training unit 210 may obtain training data which is to be used in training and may apply the obtained training data to the deep learning model, and thus, may develop the deep learning model.

The data training unit 210 may be manufactured as at least one hardware chip type and may be installed in the AI device 10. For example, the data training unit 210 may be manufactured as a dedicated hardware chip type for AI or may be manufactured as a portion of a general-use CPU or GPU and may be installed in the AI device 10. Also, the data training unit 210 may be implemented as a software module. In a case where the data training unit 210 is implemented as a software module (or a program module including an instruction), the software module may be stored in a non-transitory computer-readable recording medium. In this case, at least one software module may be provided by an operating system (OS), or may be provided by an application.

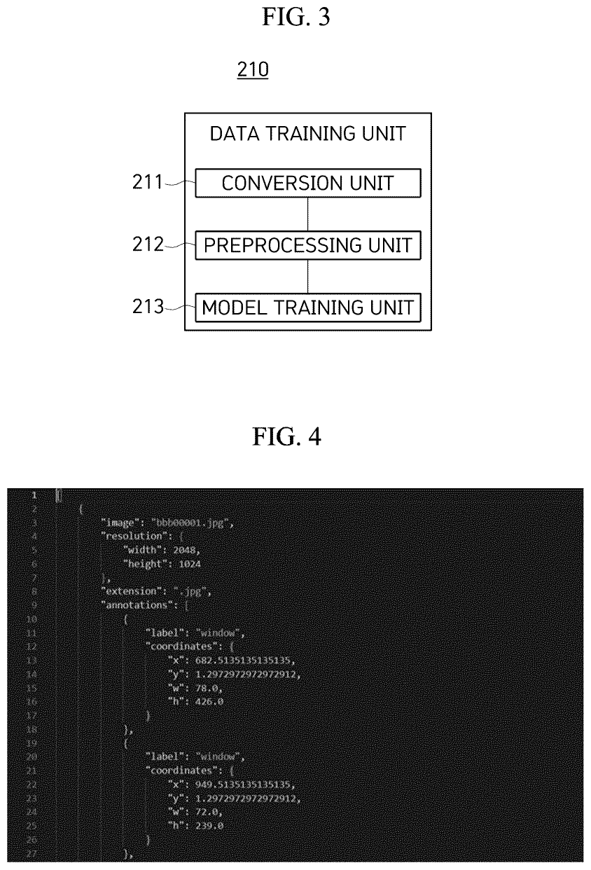

FIG. 3 illustrates an embodiment of an internal block diagram of the data training unit 210 according to the present disclosure. Referring to FIG. 3, the data training unit 210 may include a conversion unit 211, a preprocessing unit 212, and a model training unit 213, so as to analyze semantic information about a building façade according to the present disclosure.

The AI processor 200 may determine a form and a position of a detailed structure included in an individual building façade by using building façade texture data (or a building façade image) included in 3D building data obtained by the input unit. That is, the conversion unit (or an image size conversion unit) 211 may enlarge a size of a partial image extracted from building façade image representing a sub structure within the input data.

The preprocessing unit (a learning model preprocessing unit) 212 may preprocess obtained data so that the obtained data is used during data training procedure. The preprocessing unit 212 may process the obtained data in a predetermined format so that the model training unit 213 uses the obtained data for training to recognize a sub structure from an input image.

That is, the preprocessing unit 212 may preprocess for adding or for reinforcing information about the sub structure of building façade to the pre-trained model by using image data enlarged by the conversion unit 211.

The model learning unit 213 (or a building façade structure classification unit) may develop a neural network model to determine classification criteria, based upon data preprocessed by the preprocessing unit. At this time, the model learning unit 213 may develop the neural network model through a supervised learning method which uses at least a portion of learning data as the determination criterion. Alternatively, the model learning unit 213 may be autonomously trained by using the training data without any supervision, and thus, may develop the neural network model through unsupervised learning method for the determination criterion. Also, the model learning unit 213 may develop the neural network model through reinforcement learning by using feedback upon whether a result of situation determination based on learning is normal or not. Also, the model learning unit 212 may develop the neural network model by using a training algorithm including an error back-propagation or a gradient decent.

When the neural network model is developed, the model learning unit may store the trained neural network model in the memory. The model learning unit may store the trained neural network model in a memory of a server connected to the AI device through a wired or wireless network.

Moreover, the model learning unit may finally classify the sub structure within building façade by using the preprocessed data.

Subsequently, the output unit 400 may generate and store a result analyzed by the AI processor. The output unit 400 may classify a building façade semantic analysis result, performed by the AI processor, into image metadata and object data, and may store the image metadata and the object data. That is, the output unit may store the image metadata and the object data in a file form such as txt or json. FIG. 4 illustrates an embodiment of output data according to the present disclosure.

Additionally, the AI device may further include a communication unit (not shown). The communication unit may transmit an AI processing result, obtained by the AI processor 200, to an external device.

It has been described that the AI device illustrated in FIG. 1 is functionally divided into the input unit, the AI processor, the memory, the output unit, and the communication unit, but the elements described above may be integrated into one module and may be referred to as an AI module.

Moreover, the AI device may obtain 3D building data as training data so as to learn the classification of semantic information from a building façade. Also, the AI device may generate a partial image of a sub structure of the building façade in the 3D building data, may determine a magnification scale, corresponding to a size of a target image, as an image size conversion magnification scale of the partial image, may perform a preprocessing operation of converting the partial image at the determined magnification scale to obtain detailed structure data of the sub structure of the building façade, and may train an AI model with the preprocessed sub structures to classify the semantic information about the building façade structure. Also, the AI device may store the trained AI model in the memory.

Hereinafter, each learning-based step which analyzes building façade semantic information and is performed by an AI processor so as to classify analyzed information, according to the present disclosure, will be described below in more detail.

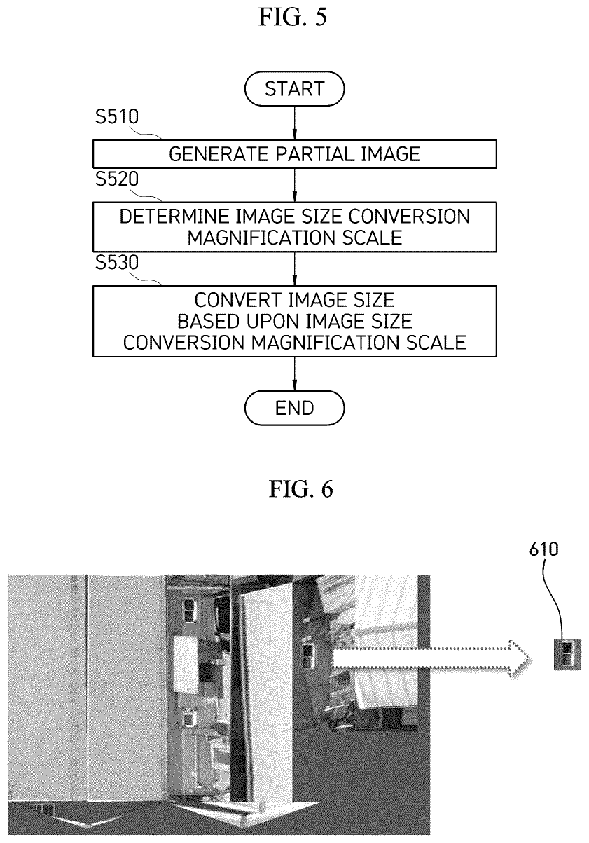

FIG. 5 is a flowchart illustrating an embodiment of an operating method of a conversion unit according to the present disclosure.

Referring to FIG. 5, a conversion unit may perform (1) partial image generating process, (2) magnification scale determination process, and (3) image interpolation process on input data.

In step S510, the conversion unit may generate a partial image including a detected target object so as to detect a window or an entrance door from a building façade texture included in 3D building data. Referring to FIG. 6, a size of a target image for generating the partial image may be set to (224, 224). FIG. 6 illustrates an embodiment which generates a partial image from input data according to the present disclosure. The conversion unit may enlarge or reduce the partial image including a building façade structure such as the window and the entrance door with respect to a size of a target image to generate a partial image 610 from the input data.

It may be important that the partial image is selected or determined as a numerical value capable of being adjusted to match to a size of the target image. Changing image size often are occurred at a fixed magnification scale, and thus, it is very difficult to adjust the size of target images to (224, 224). In step S520, the conversion unit may determine a magnification scale which can be the closest to or approximately similar to the target size, and therefore the magnification scale is finally determined with respect to a minimum dimension of an input image among magnification scales. Here, because the quality of an image finally obtained is reduced as the image size conversion magnification scale increases, the image size conversion magnification scale should not be selected as an excessively large or extremely small value.

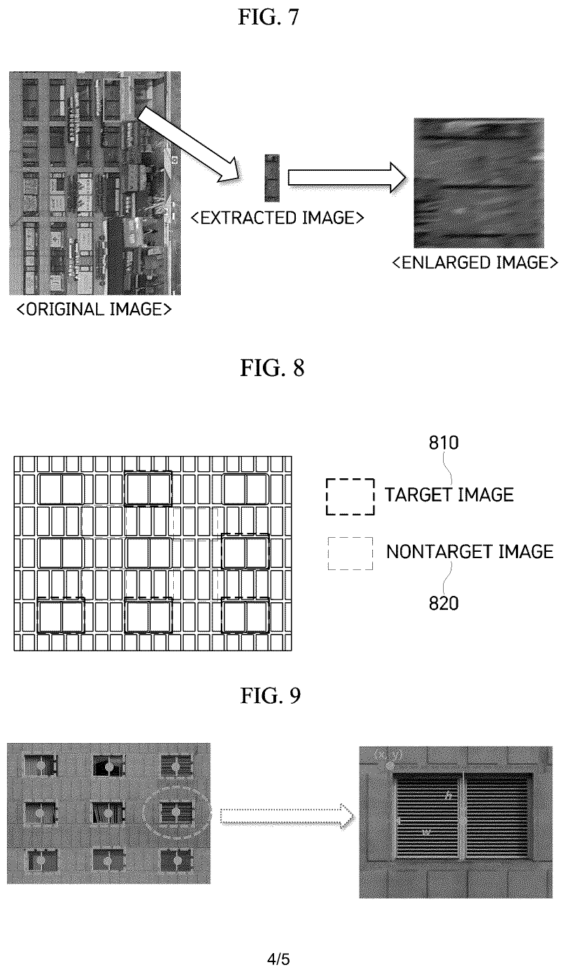

FIG. 7 illustrates an embodiment of a process of converting an image size according to the present disclosure.

Referring to FIG. 7, it may be seen that a partial image is extracted or generated from an original image, and the partial image is enlarged at an image size conversion magnification scale and is thus converted into an enlarged image.

Moreover, in step S530, the conversion unit may convert the partial image (a low-resolution image having a small size) into a high-resolution image having a large size, based on the determined image size conversion magnification scale. The conversion unit may convert the partial image into the high-resolution large image by applying various techniques such as Nearest Neighbor, Bilinear, and Bocubic, based upon available computing resource and performance, and thus, may enhance the quality of an image used in training so as to increase the accuracy of analysis of building façade semantic information and may generate an input image having a size suitable for a pre-trained model.

Subsequently, a preprocessing process for training and a process for model developing will be described in more detail.

A preprocessing unit of an AI processor may add information about a building detailed structure to a pre-trained model by using an image generated through image size conversion performed by the conversion unit described above. The information added to the pre-trained model may include a nontarget image as well as a target image of a sub structure of building façade such as a window and an entrance door, instead of a semantic classification target such as a building façade. The nontarget image may be selected in an arbitrary region of a corresponding building façade texture image on a region of a target object secured in the target image. Also, the preprocessing unit may select the number of nontarget images to be equal or similar to the number of target images.

FIG. 8 illustrates an embodiment of a target image and a nontarget image according to the present disclosure. Referring to FIG. 8, it may be seen that the number of target images 810 and the number of nontarget images 820 are equally selected to be four.

Moreover, the preprocessing unit may provide information, optimized for a sub structure of a building façade, to a pre-trained model through a transfer learning process and an image fine tuning process by using the target image and the nontarget image, and thus, may increase the accuracy of building façade semantic classification in a model training unit.

Moreover, the model training unit may classify a building façade structure from building façade texture data (or a building façade texture image) through object recognition and coordinate information calculation by using a training model generated through the preprocessing unit.

The object recognition process may denote a process of recognizing an object corresponding to a sub structure of building façade such as a window and an entrance door included in a building façade texture image, and the coordinate information calculation process may denote a process of calculating coordinates of the recognized sub structure of building façade, may calculate image coordinates of a left upper position of the recognized object, and may calculate a distance to a center of the recognized object to store the calculated image coordinates and center distance. FIG. 9 illustrates an embodiment of a process of calculating image coordinate information and recognizing an object according to the present disclosure.

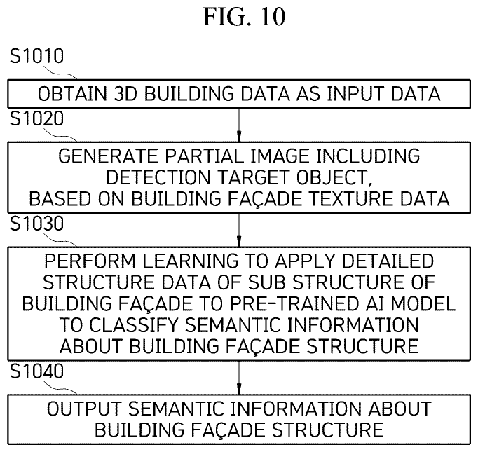

FIG. 10 illustrates an embodiment of a learning-based method of classifying building façade semantic information according to the present disclosure.

First, in step S1010, an AI device may obtain, as input data, 3D building data including building façade texture data.

The 3D building data may further include building shape data and building attribute data.

Moreover, in step S1020, the AI device may generate a partial image including a detected target object, based on the building façade texture data.

Moreover, in step S1030, the AI device may be trained to obtain detailed structure data of a sub structure of a building façade through the partial image and apply the detailed structure data to a pre-trained AI model to classify semantic information about a building façade structure.

The detailed structure data may include data corresponding to a target image corresponding to the sub structure of the building façade and data corresponding to a nontarget image instead of the target image, and the AI device may determine the number of target images and the number of nontarget images to be equal or similar to each other.

Moreover, the AI device may apply the detailed structure data of the sub structure of the building façade to the pre-trained AI model through a transfer learning and image fine tuning.

Moreover, in step S1040, the AI device may generate semantic information about the classified building façade structure.

The step S1030 may include a process of recognizing sub structure of the building façade and of extracting coordinate information from the recognized sub structure of the building façade.

Additionally, the AI device may classify the generated semantic information about the building façade structures into image metadata and object data and may store the image metadata and the object data.

The step S1020 (i.e., a step of generating a partial image) may include a process to determine a magnification scale, corresponding to a size of a target image, as an image size conversion magnification scale of the partial image and to convert the partial image at the determined magnification scale and may be performed.

The partial image may be converted from a low-resolution image having a small size into a high-resolution image having a large size, based upon the determined magnification scale.

The embodiments described above may be combined with the elements and features of the present disclosure. Unless separately and explicitly described, each element or feature should be considered to be selective. Each element or feature may be implemented in a form which is not combined with another element or feature. Also, the embodiment of the present disclosure may be configured by combining some elements and/or features with each other. The order of operations described in the embodiments of the present disclosure may be changed. Some elements or features of a certain embodiment may be included in another embodiment, or may be replaced with an element or a feature corresponding to another embodiment. In Claim, it is obvious that an embodiment may be configured by combining claims having no explicit citation relationship, or may be included as a new claim by correction after patent application.

The embodiments according to the present disclosure may be implemented by various means (for example, hardware, firmware, software, or a combination thereof). In implementation based on hardware, an embodiment of the present disclosure may be implemented by one or more application specific integrated circuits (ASICs), digital signal processors (DSPs), digital signal processing devices (DSPDs), programmable logic devices (PLDs), field programmable gate arrays (FPGAs), processors, controllers, microcontrollers, and microprocessors.

In implementation based on firmware or software, the embodiments of the present disclosure may be implemented in a form such as a module, a process, or a function, which performs functions or operations described above. A software code may be stored in a memory and may be driven by a processor. The memory may be disposed in or outside the processor and may transfer or receive data to or from the processor, based on various means known to those of ordinary skill in the art.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. An artificial intelligence (AI) device for classifying semantic information about a building façade through learning, the AI device comprising:
an input unit configured to obtain three-dimensional (3D) building data, including building façade texture data, as input data;
an AI processor trained to generate a partial image including a detected target object, based on the building façade texture data, obtain detailed structure data of a sub structure of a building façade by using the partial image, apply the detailed structure data to a pre-trained AI model to recognize the sub structure of the building façade, and extract coordinate information about the recognized sub structure of the building façade to classify semantic information about a building façade structure; and
an output unit configured to generate the semantic information about the building façade structure classified by the AI processor.

2. The AI device of claim 1, wherein the 3D building data further comprises building shape data and building attribute data.

3. The AI device of claim 1, further comprising a memory configured to classify the semantic information about the building façade structure, output by the output unit, into image metadata and object data and store the image metadata and the object data.

4. The AI device of claim 1, wherein the AI processor comprises:
a conversion unit configured to enlarge a size of image data corresponding to the sub structure of the building façade;
a preprocessing unit configured to apply detailed structure data of the sub structure of the building façade to the pre-trained AI model; and
a model training unit trained to recognize the sub structure of the building façade and classify the semantic information about the building façade structure, based on the coordinate information about the recognized sub structure of the building facade.

5. The AI device of claim 4, wherein the conversion unit generates a partial image of the sub structure of the building façade, determines a magnification scale, corresponding to a size of a target image, as an image size conversion magnification of the partial image, and converts the partial image at the determined magnification scale.

6. The AI device of claim 5, wherein the partial image is converted from a low-resolution image having a small size into a high-resolution image having a large size, based on the determined magnification scale.

7. The AI device of claim 6, wherein the detailed structure data comprises data corresponding to a target image corresponding to the sub structure of the building façade and data corresponding to a nontarget image instead of the target image.

8. The AI device of claim 7, wherein the preprocessing unit determines the number of target images to be equal or similar to the number of nontarget images.

9. The AI device of claim 8, wherein the preprocessing unit applies the detailed structure data of the sub structure of the building façade to the pre-trained AI model through transfer learning and image fine tuning.

10. A method of classifying semantic information about a building façade through learning, the method comprising:
a step of obtaining three-dimensional (3D) building data, including building façade texture data, as input data;
a step of generating a partial image including a detection target object, based on the building façade texture data;
a step of performing training to obtain detailed structure data of a sub structure of a building façade by using the partial image and apply the detailed structure data to a pre-trained artificial intelligence (AI) model to classify semantic information about a building façade structure; and
a step of generating the classified semantic information about the building façade structure.

11. The method of claim 10, wherein the step of performing the learning comprises:
a step of recognizing the sub structure of the building façade; and
a step of extracting coordinate information about the recognized sub structure of the building façade.

12. The method of claim 10, wherein the 3D building data further comprises building shape data and building attribute data.

13. The method of claim 10, further comprising a step of classifying the output semantic information about the building façade structure into image metadata and object data and storing the image metadata and the object data.

14. The method of claim 10, wherein the step of generating the partial image comprises:
a step of determining a magnification scale, corresponding to a size of a target image, as an image size conversion magnification of the partial image; and
a step of converting the partial image at the determined magnification scale.

15. The method of claim 14, wherein the partial image is converted from a low-resolution image having a small size into a high-resolution image having a large size, based on the determined magnification scale.

16. The method of claim 15, wherein the detailed structure data comprises data corresponding to a target image corresponding to the sub structure of the building façade and data corresponding to a nontarget image instead of the target image.

17. The method of claim 16, wherein the number of target images and the number of nontarget images are determined to be equal or similar to each other.

18. The method of claim 17, wherein the detailed structure data of the sub structure of the building façade is applied to the pre-trained AI model through transfer learning and image fine tuning.

19. An artificial intelligence (AI) device trained to classify semantic information about a building façade, the AI device comprising:
an AI processor configured to obtain three-dimensional (3D) building data as training data, generate a partial image of a sub structure of a building façade in the 3D building data, determine a magnification scale, corresponding to a size of a target image, as an image size conversion magnification of the partial image, convert the partial image at the determined magnification scale, train detailed structure data of the sub structure of the building façade through an AI model, and classify semantic information about a building façade structure; and
a memory configured to store the learned AI model.
